(19) United States
(12) Patent Application Publication
(10) Pub. No.: US 2026/0025911 A1
(43) Pub. Date: Jan. 22, 2026

(54) LOSS REDUCTION HIGH-SPEED DIFFERENTIAL TRANSMISSION LINES

(71) Applicant: Hewlett Packard Enterprise Development LP, Spring, TX (US)

(72) Inventors: Chi Kim Sides, Spring, TX (US); Michael Chan, Bellaire, TX (US)

(21) Appl. No.: 18/775,750

(22) Filed: Jul. 17, 2024

(51) Int. Cl. H05K 1/02; G06F 30/39; G06F 115/12

(52) U.S. Cl. CPC H05K 1/0245; G06F 30/39; H05K 1/0248; H05K 1/025; G06F 2115/12

(57) ABSTRACT

One aspect of the disclosure can provide a printed circuit board (PCB). The PCB may include one or more layers and at least a differential pair including a first transmission line and a second transmission line. The first transmission line may include a plurality of skew-compensation structures, each skew-compensation structure tuned to reduce an impedance mismatch along the differential pair. The first transmission line may be longer than the second transmission line to reduce a mismatch of signal flight times associated with the first and second transmission lines.

### BACKGROUND

### Field

This disclosure is generally related to the design of printed circuit boards (PCBs). More specifically, this disclosure is related to reducing insertion losses and impedance mismatch caused by timing skews of high-speed differential transmission lines at high frequencies.

### Related Art

A differential pair transmission line may include two conductive paths of equal length, with signals on the two paths being equal in amplitude but opposite in polarity. On a high-density PCB, due to spatial constraint, a differential pair transmission line (also referred to as a differential pair) may experience multiple bends and turns along its path, resulting in possible timing skews between the true (P) and complementary (N) signals.

Timing skew is the deviation of propagation delay from the required reference timing. For a differential pair, the main source of the timing skew (referred to as the intra-pair skew) is the length difference between the P and N signal lines. Conventional approaches to compensate for the intra-pair skew include introducing top-hat structures (e.g., the deliberate addition of a meandering or serpentine pattern) on the shorter trace of the pair to increase its length without significantly altering the overall layout of the PCB. However, as the signal speed increases, simply matching the lengths of the transmission lines in a differential pair is no longer sufficient in ensuring zero timing skew and a high degree of signal integrity.

### BRIEF DESCRIPTION OF THE FIGURES

FIG. 1 illustrates examples of differential pairs implementing different skew-compensation schemes, according to one aspect of the instant application.

FIG. 2A illustrates an example top-hat structure with tunable parameters, according to one aspect of the instant application.

FIG. 2B illustrates differential pairs used in the three-dimensional (3D) full-wave electromagnetic field (EMF) simulation, according to one aspect of the instant application.

FIG. 2C illustrates the performance of untuned top-hat structures, according to one aspect of the instant application.

FIG. 2D illustrates the performance comparison between tuned and untuned top-hat structures, according to one aspect of the instant application.

FIG. 3 illustrates the speed-up effect of the top-hat structures, according to one aspect of the instant application.

FIG. 4 illustrates an example printed circuit board (PCB), according to one aspect of the instant application.

FIG. 5 presents a flowchart illustrating an example process for reducing the intra-pair skew of a differential pair, according to one aspect of the instant application.

FIG. 6 illustrates simulated performances of a length-matched differential pair and a flight-time-matched differential pair, according to one aspect of the instant application.

FIG. 7 illustrates a computer system for facilitating the design of a differential pair on a printed circuit board (PCB), according to one aspect of the instant application.

FIG. 8 illustrates a computer-readable medium 800 which facilitates the design of a differential pair on a printed circuit board (PCB), according to one aspect of the instant application.

In the figures, like reference numerals refer to the same figure elements.

### DETAILED DESCRIPTION

Compared with single-ended signaling, differential signaling can provide a number of benefits, such as no return ground current, less electromagnetic interference (EMI), reduced crosstalk, lower voltage, etc. Differential signaling uses a pair of differential transmission lines to carry electrical signals. However, timing skews between the two transmission lines of a pair of differential transmission lines may be problematic, especially for high-frequency applications. The intra-pair skew may lead to unwanted resonances and additional channel loss.

For ultra-high-speed signal interconnects, in addition to matching the length of each trace within a differential pair (e.g., keeping the length difference within a few mils), it is also important to minimize the impedance mismatch along the transmission lines to increase the loss margin and reduce the common-mode conversion and crosstalk. Traditional approaches use serpentine segments or top-hat structures to achieve the length matching within the pair along the overall routing length. More specifically, each segment of the differential pair is length-matched.

However, although capable of keeping the physical static and dynamic skew within the differential pair under control, segment matching may generate uneven flight time between the positive and negative traces of the differential pair, thus increasing the insertion loss, mode conversion, and crosstalk. Moreover, in the ultra-high-frequency region (e.g., with a transfer rate of 224 GT/s), segment matching may create an unacceptable impedance mismatch of the differential pair in the pass band region of 224 GT/s.

According to some aspects of the instant application, the aforementioned signal-integrity-related issues can be mitigated by tunning the top-hat topology and adding more top-hat structures (or top hats for short) than what is required for the intra-pair length matching to compensate for the speed-up effects caused by the top hats. The resulting differential pair may have traces of different lengths. More specifically, the total length of the trace with top hats may be slightly longer than the trace without top hats. Moreover, instead of having top hats distributed along the path, the top hats may be arranged immediately adjacent to each other to reduce unwanted reflections.

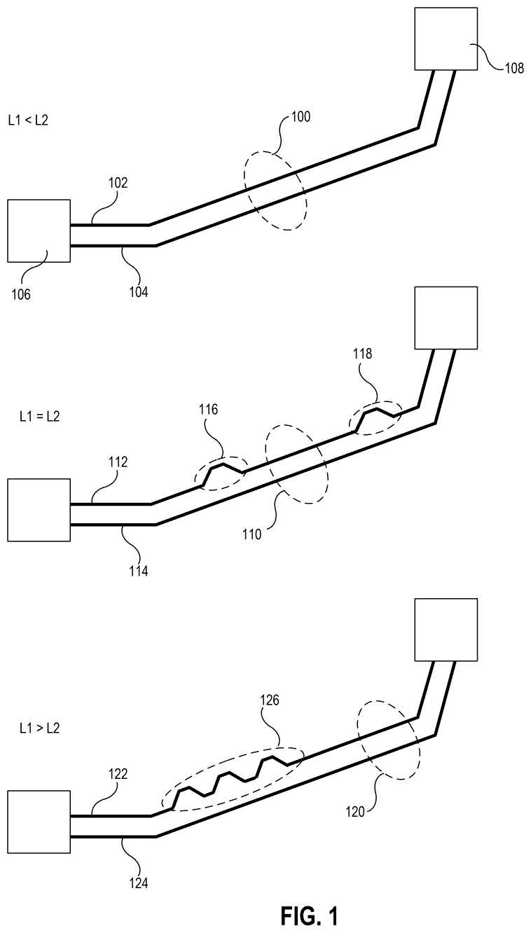

FIG. 1 illustrates examples of differential pairs implementing different skew-compensation schemes, according to one aspect of the instant application. The top drawing of FIG. 1 shows a differential pair 100 with an inner trace 102 and an outer trace 104. More specifically, FIG. 1 shows a segment of a differential pair positioned between PCB components 106 and 108. Note that a PCB component can include any discontinuous point (e.g., a device, a via, etc.) along a PCB trace. Differential pair 100 includes multiple bends or turns, which can cause outer trace 104 to be slightly longer than inner trace 102. In this example, L1<L2, where L1 denotes the length of inner trace 102, and L2 denotes the length of outer trace 104. Such a length difference can cause a timing skew (e.g., phase or group delay) between signals propagating along traces 102 and 104, which in turn can result in signal distortion. In the top drawing, no skew-compensation scheme is implemented.

The middle drawing of FIG. 1 shows a differential pair 110 with an inner trace 112 and an outer trace 114. Like differential pair 100, differential pair 110 includes multiple bends or turns. To compensate for the length difference between inner trace 112 and outer trace 114, a number of skew-compensation structures have been introduced in the shorter inner trace. A skew-compensation structure refers to the mechanism for extending the length of a straight segment of the PCB trace by deliberately introducing bends (which may be shaped like a top hat) or half circles/loops along the straight segment. In the example shown in FIG. 1, the skew-compensation structures may include top-hat structures. More specifically, inner trace 112 of pair 110 may include top-hat structures 116 and 118, which can add to its total length such that the length of inner trace 112 matches the length of outer trace 114 (i.e., L1=L2, where L1 denotes the length of inner trace 112, and L2 denotes the length of outer trace 114).

The segment-length-matching scheme works well for signals with relatively low speed (e.g., signals with a Nyquist frequency of less than 40 GHz). For example, the transfer rate of a Peripheral Component Interconnect Express (PCIe) 4.0 bus can be about 16 GT/s, and the segment-length-matching scheme can adequately compensate for the intra-pair skew without distorting the signals. However, as the signal speed increases (e.g., in interconnects operating at the transfer rate of 224 GT/s or beyond), the non-uniform impedance distribution along the signal lines or traces caused by the skew-compensation structures (e.g., top hats) may create unwanted impedance mismatch, especially at higher frequencies, thus causing deviation in the insertion loss and phase delays.

Conventional approaches to mitigating the impedance variation caused by the top-hat structures include spreading the top-hat structures along the length of the differential pair (e.g., as shown in the middle drawing of FIG. 1) and limiting the maximum number of top-hat structures to two or three locally, or decreasing the height of each top-hat structure (which can reduce the difference in spacing but will require more top-hat structures to compensate for the timing skew). However, these approaches do not apply to PCBs that require high-density signal routing with minimal spacing because the redistribution of these top-hat structures may be limited by space availability. In addition, limiting the number of top-hat structures may cause insufficient timing-skew compensation. Other approaches include modifying the trace width of each top-hat structure to reduce the impedance non-uniformity. However, such an approach requires varying the width of a PCB trace, which can be cumbersome for PCB designers.

The impedance of each top-hat structure depends on both the PCB stackup (i.e., the arrangement of the various layers, including the ground layer, the power layer, and the signal layers, of the PCB) and the shape of the top hat. According to some aspects of the instant application, the shape of each top hat can be tuned to minimize the impedance mismatch between a segment of the differential pair with top hats and a segment of the same differential pair without top hats. In other words, the impedance of the transmission pair varies along its length, which can cause unwanted signal distortion.

Merely matching the segment length of the two traces in the differential pair cannot sufficiently compensate for the intra-pair skew due to the speed-up effect of the top-hat structures. More specifically, the flight time of the trace with top hats is faster than the flight time of the trace of the same length without top hats. Although the physical length of the positive and negative traces within a differential pair may be well matched, the electrical length of the positive and negative traces may be different due to the existence of the top hats. This intra-pair electrical skew of the differential transmission lines causes the mode conversion from differential to the common mode, which in turn can result in a higher insertion loss and crosstalk. The electrical intra-pair skew, therefore, may degrade the performance of an ultra-high-speed channel significantly.

To compensate for the speed-up effects of the top hats, according to some aspects of the instant application, instead of matching the length of the two traces in the differential pair, the PCB design system can match the flight time of the positive and negative traces, which may include adding an appropriate additional number of top hats to compensate for the speed-up effect. Moreover, instead of spreading the top hats along the length of the differential pair, the multiple top hats may be arranged immediately adjacent to one another. This arrangement can prevent the insertion loss deviation from spreading to lower frequencies.

The bottom drawing of FIG. 1 shows a differential pair 120 with an inner trace 122 and an outer trace 124. Like differential pairs 100 and 110, differential pair 120 includes multiple bends or turns. To match the signal flight time between traces 122 and 124, a plurality of top hats 126 may be included in inner trace 122 such that the length of inner trace 122 can be slightly greater than the length of outer trace 124 (i.e., L1>L2, where L1 denotes the length of inner trace 122, and L2 denotes the length of outer trace 124). Moreover, the shape of each top-hat structure has been carefully tuned to minimize the impedance mismatch along differential pair 120.

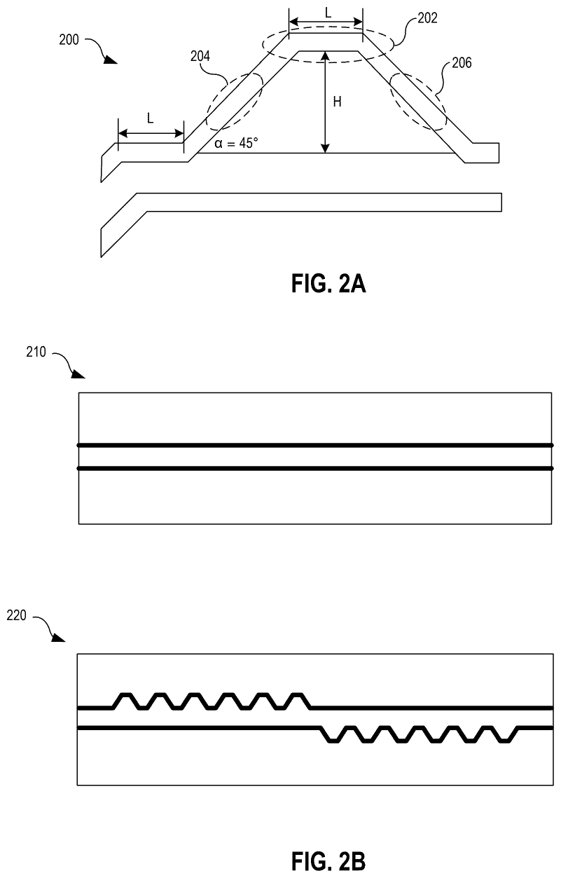

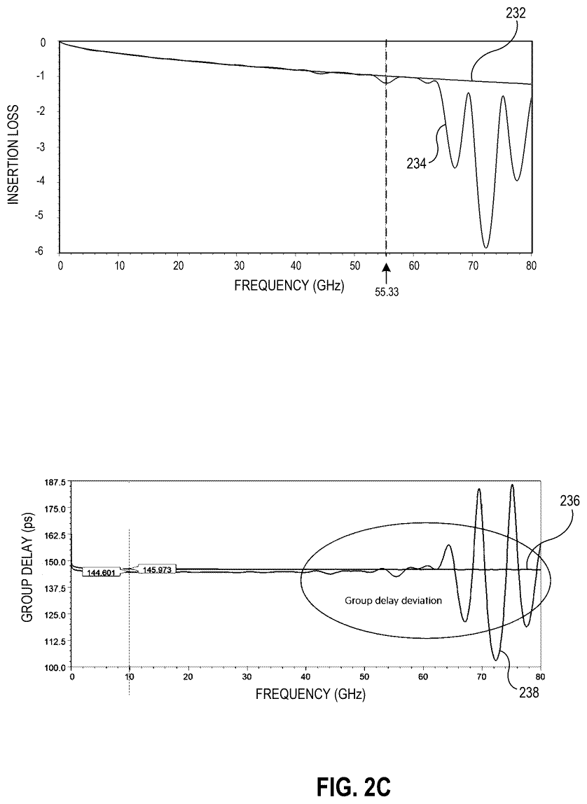

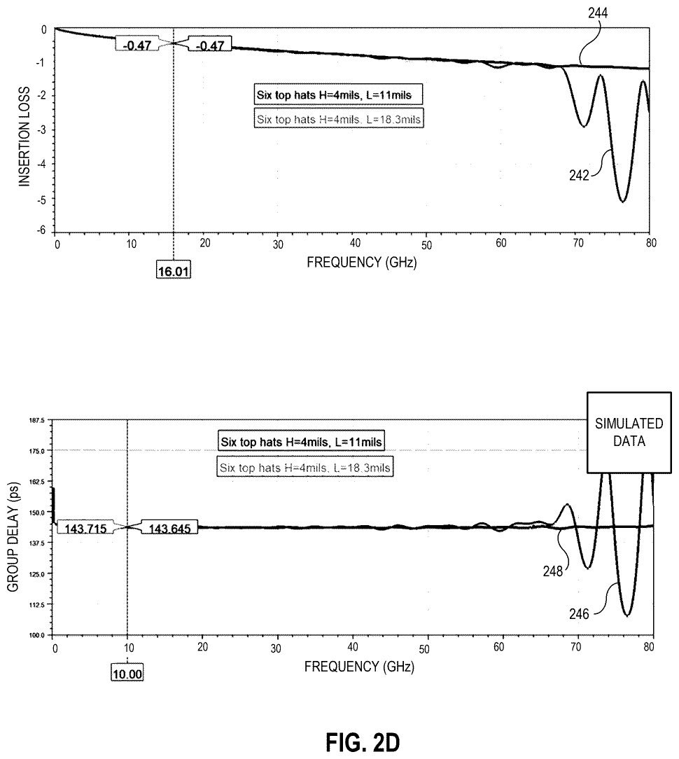

FIG. 2A illustrates an example top-hat structure with tunable parameters, according to one aspect of the instant application. In FIG. 2A, a top-hat structure 200 may include a top segment 202 and two rising edges 204 and 206. The length of top segment 202 is denoted L, the height of top-hat structure 200 (i.e., the vertical distance from top segment 202 to the base of the rising edges) is denoted H, and the angle formed by a rising edge and its base is denoted α.

The impedance of top-hat structure 200 can be determined based on the structure of the PCB stackup (e.g., the number of layers and the material of each layer) and the shape parameters of the top hat (i.e., L, H, and α). The impedance of top-hat structure 200 may be tuned by tuning the shape parameters (i.e., by adjusting the values of L, H, and α). To simplify the design process, according to some aspects, a may be set to a fixed value. In the example shown in FIG. 2A, angle α is set as 45°. In addition, the minimum distance between the rising edge of the top hat to a corner in the transmission line may be set as L. Similarly, the minimum distance between adjacent top hats may be set as L.

According to some aspects, a three-dimensional (3D) full-wave electromagnetic field (EMF) solver may be used to tune the shape parameters of the top hat to reduce the impedance mismatch between a segment of the differential pair with top hats and a segment without top hats.

FIG. 2B illustrates differential pairs used in the three-dimensional (3D) full-wave electromagnetic field (EMF) simulation, according to one aspect of the instant application. The top drawing of FIG. 2B shows a differential pair 210, which includes a pair of transmission lines without top-hat structures. The bottom drawing of FIG. 2B shows a differential pair 220, which includes a pair of transmission lines with top-hat structures. More specifically, to ensure the equal length of the traces in differential pair 220, each trace in differential pair 220 may include the same number of top hats. In this example, each trace may include six top-hat structures. It is also possible to include more or fewer top-hat structures. Moreover, to eliminate the effect of the PCB stackup, differential pairs 210 and 220 have the same PCB stackup.

To optimize the shape of the top-hat structures, one may first run a 3D EMF simulation on differential pair 210 to determine various parameters associated with the performance of differential pair 210, including but not limited to insertion loss and group delay. Subsequently, one may run the 3D EMF simulation on differential pair 220 by iteratively tuning or adjusting the length of the top segment and the height of the top-hat structures to match, at least in the frequency range of interest, the impedance of differential pair 220 to the impedance of differential pair 210. According to one aspect, the PCB design system may first choose a predetermined height value (i.e., H), which is often constrained by the available PCB space (e.g., the distance between traces). Given the value of H, the 3D full-wave EMF simulation may be run iteratively for different L values until an optimum L value is identified. Note that when L is tuned, the length of each rising edge is tuned accordingly.

FIG. 2C illustrates the performance of untuned top-hat structures, according to one aspect of the instant application. The top drawing of FIG. 2C shows the insertion loss as a function of frequency for differential pair 210 (curve 232) and differential pair 220 with untuned top hats (curve 234). The bottom drawing of FIG. 2C shows the group delay as a function of frequency for differential pair 210 (curve 236) and differential pair 220 with tuned or optimized top hats (curve 238). As can be seen from FIG. 2C, when the shape of the top hats is not optimized at the frequency band of interest (e.g., 55.33 GHz, which corresponds to a transfer rate of about 224 GT/s for PAM-4 signals), the insertion loss and group delay of differential pair 220 are significantly different from those of differential pair 210. More specifically, the untuned top hats may introduce more insertion loss and deviations in group delay in the frequency range of interest (e.g., around 55.33 GHz).

FIG. 2D illustrates the performance comparison between tuned and untuned top-hat structures, according to one aspect of the instant application. The top drawing of FIG. 2D shows the insertion loss as a function of frequency for a differential pair with non-optimal top hats (curve 242) and a differential pair with optimal top hats (curve 244). The bottom drawing of FIG. 2D shows the group delay as a function of frequency for a differential pair with non-optimal top hats (curve 246) and a differential pair with optimal top hats (curve 248). In this example, both hot-hat structures have the same height (i.e., H=4 mils), and the top segment of the optimal top hat is shorter (i.e., L=11 mils) than the top segment of the non-optimal top hat (i.e., L=18.3 mils). As can be seen in FIG. 2C, compared with a differential pair with non-optimal top hats, a differential pair with optimal top hats experiences less insertion loss and deviations in group delay in the frequency range of interest (e.g., around 55.33 GHz).

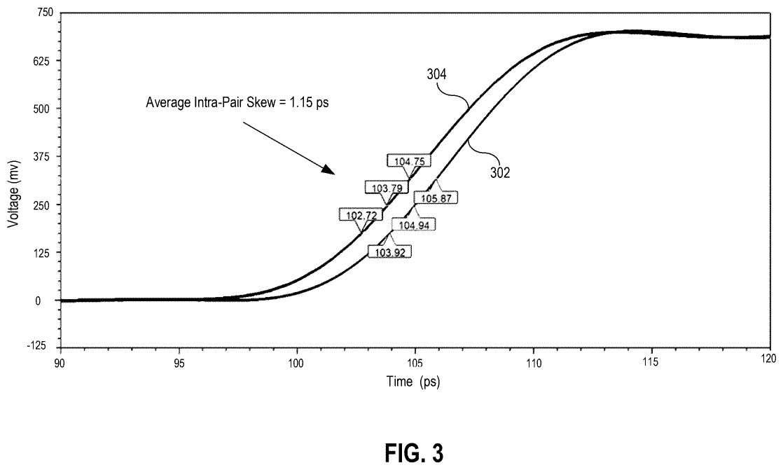

FIG. 3 illustrates the speed-up effect of the top-hat structures, according to one aspect of the instant application. In this example, the rising edge of a propagated signal is shown for the positive and negative traces of a differential pair. For comparison, the polarity of the signal propagating in the negative trace is reversed, and both traces have the same length. In FIG. 3, curve 302 corresponds to a signal propagating in the trace without the top hats, and curve 304 corresponds to a signal propagating in the trace with five carefully tuned top hats. As shown FIG. 3, the rising edge of the signal represented by curve 304 arrives before the rising edge of curve 302. In other words, the signal travels faster in the trace with top hats than the trace without top hats. More particularly, in this case, the arriving time difference is measured at different points on the rising edge, and the average intra-pair skew is about 1.15 ps.

Note that the intra-pair skew shown in FIG. 3 is not caused by the length difference between the traces. This effect is caused by the coupling among the top-hat structures, which pulls the speed of the signal propagating faster than expected. To compensate for this speed-up effect, the trace with the top hats should be extended slightly longer than the one without. According to some aspects of the instant application, additional top hats may be added. In the example shown in FIG. 1, although two top hats can sufficiently match the length of the two traces (e.g., the traces in differential pair 110), the differential pair in the bottom drawing includes three top hats. In other words, differential pair 120 includes one additional top hat compared with differential pair 110. This additional top hat is used to compensate for the speed-up effect of the top hats.

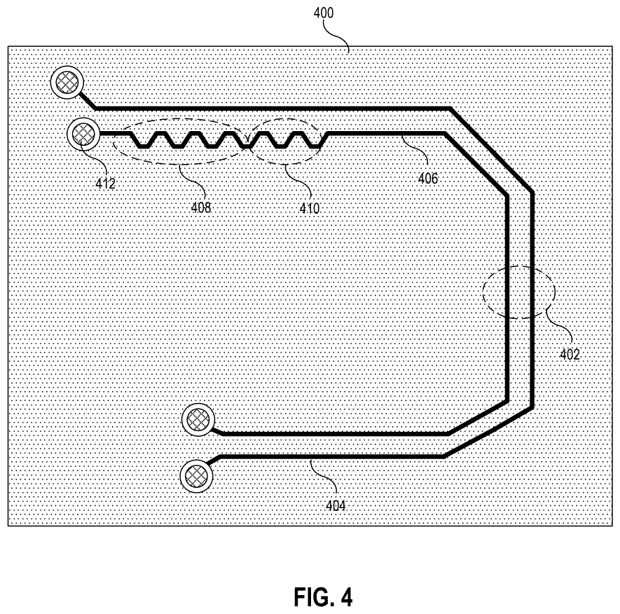

FIG. 4 illustrates an example printed circuit board (PCB), according to one aspect of the instant application. In FIG. 4, PCB 400 may be a multilayer PCB that comprises one or more dielectric layers and multiple metal layers, with adjacent metal layers being separated by a dielectric layer. The signal layer of PCB 400 may include a differential pair 402 with an outer transmission line 404 and an inner transmission line 406. Due to the required bends and turns, inner transmission line 406 (which may carry the true signal), may be shorter than outer transmission line 404 (which may carry the complimentary signal). To compensate for the intra-pair skew, inner transmission line 406 may include a number of skew-compensation structures (e.g., top-hat structures). More specifically, the skew-compensation structures may include a first group 408 used to compensate for the length difference between the inner and outer transmission lines and a second group 410 used to compensate for the speed-up effect caused by the skew-compensation structures. In this example, first group 408 may include four skew-compensation structures, and second group 410 may include two skew-compensation structures. The number of skew-compensation structures may vary, depending on the practical need. FIG. 4 also shows that the transmission lines are coupled to corresponding signal vias (e.g., via 412), which allow the transmission lines to be connected to components in the same layer or signal traces/ground in other layers.

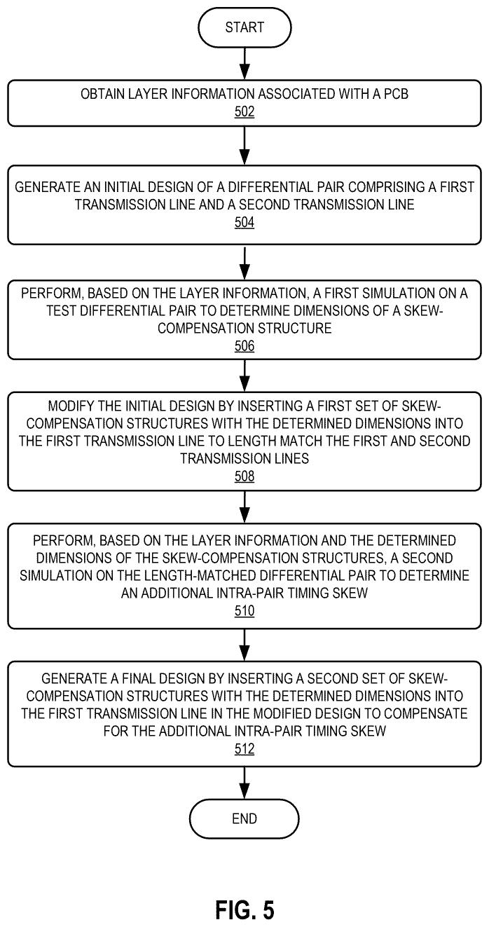

FIG. 5 presents a flowchart illustrating an example process for reducing the intra-pair skew of a differential pair, according to one aspect of the instant application. During operation, a PCB design system may obtain layer information associated with the PCB (operation 502). The layer information may be inputted into the PCB design system manually by the designer. Alternatively, the PCB design system may obtain the layer information by accessing one or more PCB-design files (e.g., Gerber files). The layer information can include the number of layers and the material used for each layer in the PCB. Additional basic design parameters such as the width of the signal traces and the minimum spacing between the traces of a differential pair, may also be obtained. Note that the higher the signal speed, the larger the spacing.

The PCB design system may generate an initial design of a differential pair comprising a first transmission line and a second transmission line (operation 504). For example, based on the desired placement of the components and a number of design constraints (e.g., the available board space, the range of the trace width, the minimum spacing between adjacent traces, etc.), the PCB design system may route signals from one PCB component to another via a pair of traces with a predetermined trace width and spacing. The initial design of the differential pair typically may include a number of bends and turns. The initial design may be similar to differential pair 100 shown in FIG. 1.

The PCB design system may perform, based on the layer information, a first simulation on a test differential pair to determine the dimensions of a skew-compensation structure (operation 506). The test differential pair may be similar to differential pair 220 shown in FIG. 2B, and the skew-compensation structure may be similar to top-hat structure 200 shown in FIG. 2A. According to some aspects, running the first simulation may involve performing a 3D full-wave electromagnetic field (EMF) simulation to adjust the lengths of the top segment and rising edges to reduce an impedance mismatch along the differential pair. In one example, one may select a predetermined value for the length of the rising edge (such a value may be determined based on the minimum pacing between traces and the angle between the rising edge and the base of the top hat). For each length value of the top segment, the 3D full-wave EMF simulation on the test differential pair may output the frequency response of the insertion loss and group delay (similar to the ones shown in FIGS. 2C and 2D). The PCB design system may iteratively adjust the length of the top segment to minimize the insertion loss and group delay in the desired frequency range. According to some aspects, the optimization of the length of the top segment may continue until the insertion loss and/or group delay within the desired frequency range is below a predetermined threshold. It is also possible to first select a predetermined value for the length of the top segment and then adjust the length of the rising edge. A more precise but computationally expensive approach may involve two iteration loops to adjust both lengths of the top segment and the rising edge.

The PCB design system may modify the initial design by inserting a first set of skew-compensation structures with the determined dimensions into the first transmission line to length match the first and second transmission lines (operation 508). More specifically, the length difference between the transmission lines may be calculated based on the number of turns and the turning radius, and the number of the skew-compensation structures in the first set may be determined based on the length difference between the transmission lines and the length difference between a top-hat structure and a corresponding straight segment. Alternatively, the length difference between the transmission lines may be measured. The first set of skew-compensation structures may be arranged adjacent to one another. According to one aspect, the skew-compensation structures may include top-hat structures arranged in such a way that a spacing between adjacent top-hat structures substantially equals the length of the top segment of each top-hat. The modified design may be similar to differential pair 110 shown in FIG. 1. According to some aspects, the modified design of the transmission pair may be outputted and presented to the PCB designer, allowing the PCB designer to check for possible errors or violations. For example, the PCB designer may check whether the top hat is too high, causing unwanted interference to signal propagating along adjacent traces.

Subsequently, the PCB design system may perform, based on the layer information and the determined dimensions of the skew-compensation structures, a second simulation on the length-matched differential pair to determine an additional intra-pair timing skew (operation 510). According to some aspects, running the second simulation may involve performing a 3D full-wave electromagnetic field (EMF) simulation to determine the amount of signal speed-up caused by the first set of skew-compensation structures. For example, the arrival time of the rising edge of the signal in each transmission line can be measured to determine the intra-pair timing skew caused by the top-hat speed-up effect. The offset between the rising edges (as shown in FIG. 3) corresponds to the speed-up rate of the first set of skew-compensation structures.

The PCB design system may then generate a final design by inserting a second set of skew-compensation structures with the determined dimensions into the first transmission line in the modified design to compensate for the additional intra-pair timing skew (operation 512). For example, the design system can compute the speed-up rate of each skew-compensation structure based on the additional intra-pair timing skew determined in operation 510 and the number of top hats in the first set. The PCB design system may then calculate the number of additional skew-compensation structures needed to compensate for the speed-up effect. The final design may be similar to the differential pair 120 shown in FIG. 1. Note that the PCB design system may need to determine whether there is sufficient space to place the second set of skew-compensation structures adjacent to the first set of skew-compensation structures. If not, the second set of skew-compensation structures may be placed in other locations along the differential pair. According to some aspects, the PCB design system may output the number of additional skew-compensation structures to allow the PCB designer to insert these additional skew-compensation structures into the differential pair manually.

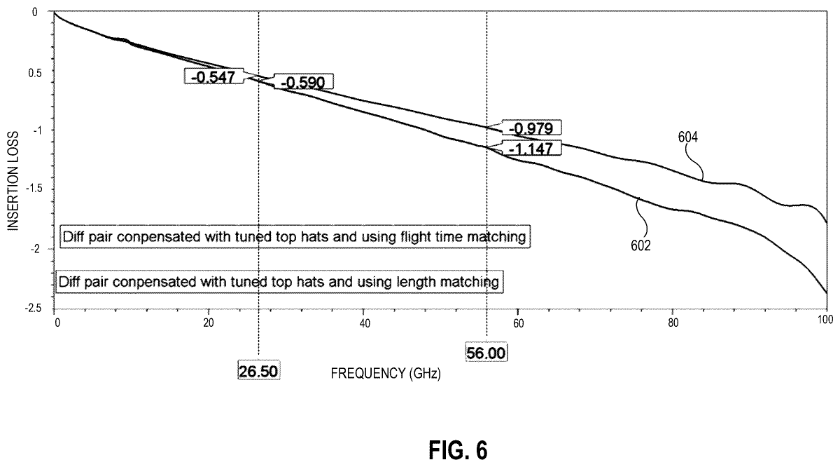

FIG. 6 illustrates simulated performances of a length-matched differential pair and a flight-time-matched differential pair, according to one aspect of the instant application. More specifically, curve 602 shows the frequency response of the insertion loss of a differential pair that is length matched (e.g., by inserting optimized top-hat structures into the shorter transmission line), and curve 604 shows the frequency response of the insertion loss of a differential pair that is flight-time matched (e.g., by inserting additional top-hat structures into the transmission line with top-hat structures). As shown in FIG. 6, the flight-time-matched differential pair has lower insertion losses than the differential pair that is simply length matched. Moreover, the difference in the insertion loss is less significant in the lower frequency band (e.g., around 26.5 GHz) than in the higher frequency band (e.g., around 56 GHz).

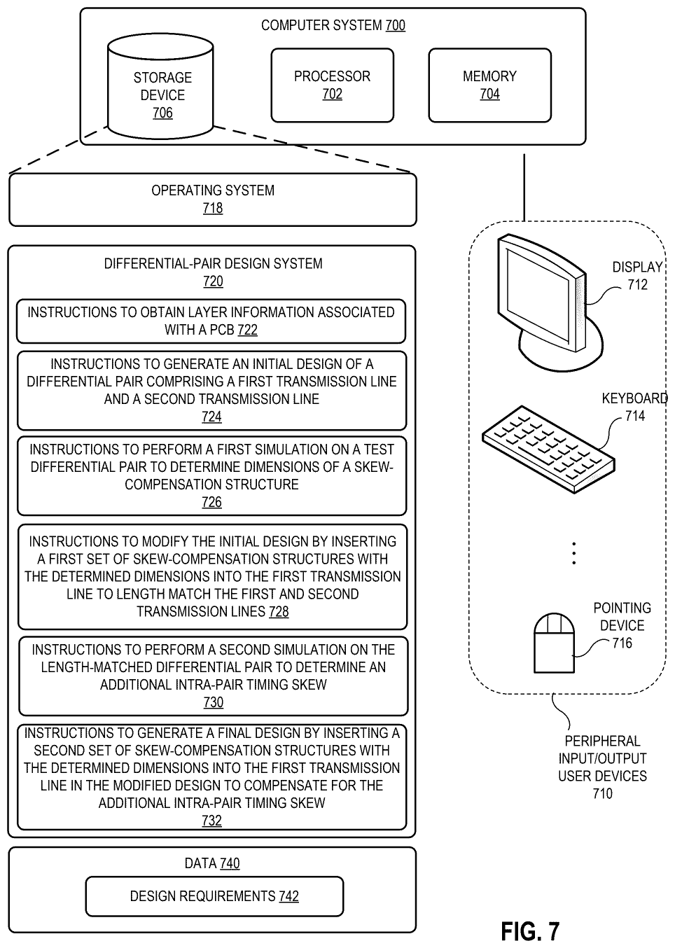

FIG. 7 illustrates a computer system for facilitating the design of a differential pair on a printed circuit board (PCB), according to one aspect of the instant application. Computer system 700 includes a processor 702, a memory 704, and a storage device 706. Memory 704 may include a volatile memory (e.g., random access memory (RAM)) that serves as a managed memory and may be used to store one or more memory pools. Furthermore, computer system 700 may be coupled to peripheral I/O user devices 710 (e.g., a display device 712, a keyboard 714, and a pointing device 716). Storage device 706 includes non-transitory computer-readable storage medium and stores an operating system 718, a differential-pair design system 720, and data 740. Computer system 700 may include fewer or more entities or instructions than those shown in FIG. 7.

Differential-pair design system 720 may include instructions, which when executed by computer system 700, may cause computer system 700 to perform methods and/or processes described in this disclosure. Specifically, differential-pair design system 720 may include instructions 722 to obtain layer information associated with a PCB (e.g., PCB 400 shown in FIG. 4). The layer information can include the number of layers, the thickness and material of each layer, etc.

Differential-pair design system 720 may include instructions 724 to generate an initial design of a differential pair comprising a first transmission line and a second transmission line. The initial design may be similar to differential pair 100 shown in FIG. 1 and may include multiple bends and turns. As discussed previously, the two traces in the pair may have different lengths, causing intra-pair timing skew.

Differential-pair design system 720 may include instructions 726 to perform a first simulation on a test differential pair to determine the dimensions of a skew-compensation structure. The test differential pair may be similar to differential pair 220 shown in FIG. 2B, and each skew-compensation structure may be similar to top-hat structure 200 shown in FIG. 2A. The result of the first simulation may be similar to those shown in FIG. 2D.

Differential-pair design system 720 may include instructions 728 to modify the initial design by inserting a first set of skew-compensation structures with the determined dimensions into the first transmission line to length match the first and second transmission lines. The length-matched differential pair may be similar to differential pair 110 shown in FIG. 1.

Differential-pair design system 720 may include instructions 730 to perform a second simulation on the length-matched differential pair to determine an additional intra-pair timing skew. The result of the second simulation may be similar to what is shown in FIG. 3.

Differential-pair design system 720 may include instructions 732 to generate a final design by inserting a second set of skew-compensation structures with the determined dimensions into the first transmission line in the modified design to compensate for the additional intra-pair timing skew. The generated final design may be similar to differential pair 120 shown in FIG. 1, in which the transmission line with the top-hat structures is slightly longer than the other transmission line.

Data 740 may include any data that is required as input or that is generated as output by the methods, operations, communications, and/or processes described in this disclosure. In one example, data 740 may include PCB design requirements 742, such as space constraints. Differential-pair design system 720 may include more instructions than those shown in FIG. 7.

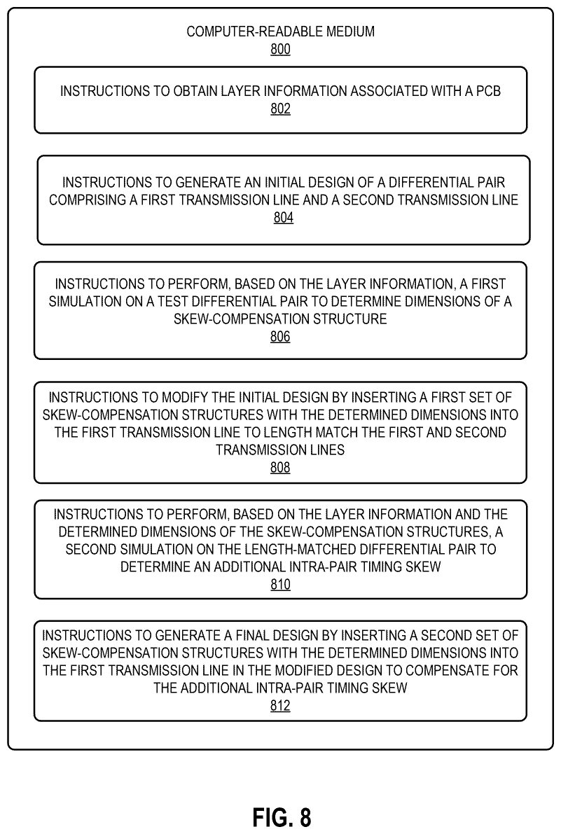

FIG. 8 illustrates a computer-readable medium 800 which facilitates the design of a differential pair on a printed circuit board (PCB), according to one aspect of the instant application. CRM 800 may be a non-transitory computer-readable medium or device storing instructions that when executed by a computer or processor cause the computer or processor to perform a method. CRM 800 may store instructions 802 to obtain layer information associated with a PCB (e.g., PCB 400 shown in FIG. 4). The layer information can include the number of layers, the thickness and material of each layer, etc.

CRM 800 may store instructions 804 to generate an initial design of a differential pair comprising a first transmission line and a second transmission line; instructions 806 to perform, based on the layer information, a first simulation on a test differential pair to determine dimensions of a skew-compensation structure; instructions 808 to modify the initial design by inserting a first set of skew-compensation structures with the determined dimensions into the first transmission line to length match the first and second transmission lines; instructions 810 to perform, based on the layer information and the determined dimensions of the skew-compensation structures, a second simulation on the length-matched differential pair to determine an additional intra-pair timing skew; and instructions 812 to generate a final design by inserting a second set of skew-compensation structures with the determined dimensions into the first transmission line in the modified design to compensate for the additional intra-pair timing skew. CRM 800 may include more instructions than those shown in FIG. 8.

One aspect of the disclosure can provide a printed circuit board (PCB). The PCB may include one or more layers and at least a differential pair including a first transmission line and a second transmission line. The first transmission line may include a plurality of skew-compensation structures, each skew-compensation structure tuned to reduce an impedance mismatch along the differential pair. The first transmission line may be longer than the second transmission line to reduce a mismatch of signal flight times associated with the first and second transmission lines.

In a variation on the aspect, a respective skew-compensation structure may include a top segment and two rising edges, and lengths of the top segment and the rising edges may be tuned to reduce the impedance mismatch along the differential pair.

In a further aspect, the plurality of skew-compensation structures may be positioned adjacent to one another.

In a further aspect, a spacing between adjacent skew-compensation structures substantially equals the length of the top segment.

In a further aspect, the skew-compensation structure may be tuned by: constructing a test differential pair on the PCB, the test differential pair comprising a pair of transmission lines of a same length, and each transmission line comprising a plurality of test skew-compensation structures; performing a three-dimensional (3D) full-wave electromagnetic field (EMF) simulation on the test differential pair; and adjusting the lengths of the top segment and rising edges of the test skew-compensation structures based on an outcome of the 3D full-wave EM simulation.

In a variation on the aspect, the plurality of skew-compensation structures may include a first set of skew-compensation structures to compensate for a length difference between the first and second transmission lines and a second set of skew-compensation structures to compensate for a speed-up effect caused by the plurality of skew-compensation structures.

In a further variation, a total number of the first set of skew-compensation structures may be determined based on the length difference between the first and second transmission lines without the skew-compensation structures, and a total number of the second set of skew-compensation structures is determined by performing a three-dimensional (3D) full-wave electromagnetic field (EMF) simulation on the pair of differential transmission lines with both sets of the skew-compensation structures.

One aspect of the disclosure can provide a method, a computer system, and a computer-readable medium which facilitate the design of a differential pair in a printed circuit board (PCB). During operation, the system may obtain layer information associated with the PCB, generate an initial design of the differential pair comprising a first transmission line and a second transmission line, and perform, based on the layer information, a first simulation on a test differential pair to determine dimensions of a skew-compensation structure. The system may further modify the initial design by inserting a first set of skew-compensation structures with the determined dimensions into the first transmission line to length match the first and second transmission lines and perform, based on the layer information and the determined dimensions of the skew-compensation structure, a second simulation on the length-matched pair of differential transmission lines to determine an additional timing skew. The system may generate a final design by inserting a second set of skew-compensation structures with the determined dimensions into the first transmission line in the modified initial design to compensate for the additional timing skew.

The methods and processes described in the detailed description section can be embodied as code and/or data, which may be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above may be included in hardware modules or apparatus. The hardware modules or apparatus may include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A printed circuit board (PCB), the PCB comprising:
one or more layers; and
at least a differential pair comprising a first transmission line and a second transmission line;
the first transmission line comprising a plurality of skew-compensation structures, each skew-compensation structure tuned to reduce an impedance mismatch along the differential pair, and
the first transmission line being longer than the second transmission line to reduce a mismatch of signal flight times associated with the first and second transmission lines.

2. The PCB of claim 1, wherein a respective skew-compensation structure comprises a top segment and two rising edges, and wherein lengths of the top segment and the rising edges are tuned to reduce the impedance mismatch along the differential pair.

3. The PCB of claim 2, wherein the plurality of skew-compensation structures are positioned adjacent to one another.

4. The PCB of claim 3, wherein a spacing between adjacent skew-compensation structures substantially equals a length of the top segment.

5. The PCB of claim 2, wherein the lengths of the top segment and rising edges are tuned by:
constructing a test differential transmission pair on the PCB, the test differential transmission pair comprising a pair of transmission lines of a same length, and each transmission line comprising a plurality of test skew-compensation structures;
performing a three-dimensional (3D) full-wave electromagnetic field (EMF) simulation on the test differential transmission pair; and
adjusting the lengths of the top segment and rising edges of the test skew-compensation structures based on an outcome of the 3D full-wave EM simulation.

6. The PCB of claim 1, wherein the plurality of skew-compensation structures comprise a first set of skew-compensation structures to compensate for a length difference between the first and second transmission lines and a second set of skew-compensation structures to compensate for a speed-up effect caused by the plurality of skew-compensation structures.

7. The PCB of claim 6, wherein a total number of the first set of skew-compensation structures is determined based on the length difference between the first and second transmission lines without the skew-compensation structures, and wherein a total number of the second set of skew-compensation structures is determined by performing a three-dimensional (3D) full-wave electromagnetic field (EMF) simulation on the pair of differential transmission lines with both sets of the skew-compensation structures.

8. A computer-implemented method for designing a pair of differential transmission lines on a printed circuit board (PCB), comprising:
obtaining layer information associated with the PCB;
generating an initial design of the pair of differential transmission lines comprising a first transmission line and a second transmission line;
performing, based on the layer information, a first simulation on a test differential pair to determine dimensions of a skew-compensation structure;
modifying the initial design by inserting a first set of skew-compensation structures with the determined dimensions into the first transmission line to length match the first and second transmission lines;
performing, based on the layer information and the determined dimensions of the skew-compensation structure, a second simulation on the length-matched pair of differential transmission lines to determine an additional intra-pair timing skew; and
generating a final design by inserting a second set of skew-compensation structures with the determined dimensions into the first transmission line in the modified initial design to compensate for the additional intra-pair timing skew.

9. The method of claim 8, wherein a respective skew-compensation structure comprises a top segment and two rising edges, and wherein performing the first simulation comprising tuning lengths of the top segment and rising edges to reduce an impedance mismatch along the pair of differential transmission lines.

10. The method of claim 9, wherein inserting the first and second sets of skew-compensation structures comprises arranging the skew-compensation structures adjacent to one another.

11. The method of claim 10, wherein the skew-compensation structures are arranged such that a spacing between adjacent skew-compensation structures substantially equals a length of the top segment.

12. The method of claim 8, wherein the first and second simulations comprise three-dimensional (3D) full-wave electromagnetic field (EMF) simulations.

13. The method of claim 8, wherein the test differential pair comprises a pair of transmission lines of equal lengths, with each transmission line comprising a plurality of test skew-compensation structures.

14. The method of claim 8, further comprising determining a number of skew-compensation structures to compensate for the additional intra-pair timing skew.

15. A computer system comprising:
a processing resource; and
a non-transitory machine-readable storage medium comprising instructions executable by the processing resource to:
obtain layer information associated with a PCB;
generate an initial design of a pair of differential transmission lines comprising a first transmission line and a second transmission line;
perform, by the processing resource based on the layer information, a first simulation on a test differential transmission pair to determine dimensions of a skew-compensation structure;
modify the initial design by inserting a first set of skew-compensation structures with the determined dimensions into the first transmission line to length match the first and second transmission lines;
perform, by the processing resource based on the layer information and the determined dimensions of the skew-compensation structure, a second simulation on the length-matched pair of differential transmission lines to determine an additional time skew; and
generate a final design of the pair of differential transmission lines by inserting a second set of skew-compensation structures with the determined dimensions into the first transmission line in the modified initial design to compensate for the additional time skew.

16. The computer system of claim 15, wherein a respective skew-compensation structure comprises a top segment and two rising edges, and wherein performing the first simulation comprising tuning the lengths of the top segment and the rising edges to reduce an impedance mismatch along the pair of differential transmission lines.

17. The computer system of claim 16, wherein inserting the first and second sets of skew-compensation structures comprises arranging the skew-compensation structures adjacent to one another.

18. The computer system of claim 17, wherein the skew-compensation structures are arranged such that a spacing between adjacent skew-compensation structures substantially equals a length of the top segment.

19. The computer system of claim 15, wherein the first and second simulations comprise three-dimensional (3D) full-wave electromagnetic field (EMF) simulations.

20. The computer system of claim 15, wherein the test differential transmission pair comprises a pair of transmission lines of equal lengths, with each transmission line comprising a plurality of test skew-compensation structures.
